(19) United States
(12) Patent Application Publication
(10) Pub. No.: US 2019/0351993 A1
(43) Pub. Date: Nov. 21, 2019

(54) AIRCRAFT STABILIZER

(71) Applicants: PETER BENNETT HOUSER, POWAY, CA (US); JESSICA MARIE LAVIGNE, SAN DIEGO, CA (US)

(72) Inventors: PETER BENNETT HOUSER, POWAY, CA (US); JESSICA MARIE LAVIGNE, SAN DIEGO, CA (US)

(73) Assignee: NORTHROP GRUMMAN SYSTEMS CORPORATION, FALLS CHURCH, VA (US)

(21) Appl. No.: 15/980,319

(22) Filed: May 15, 2018

(51) Int. Cl. B64C 5/02; B64D 47/08

(52) U.S. Cl. CPC B64C 5/02; B64D 47/08

(57) ABSTRACT

A stabilizer for an aircraft tail includes a housing defining an interior. The housing is releasably connected to the aircraft tail. A mission-specific equipment package is stowed in the housing interior.

### TECHNICAL FIELD

The present invention relates generally to aircraft stabilizers and, more specifically relates to an electronics pod that also functions as an aircraft stabilizer.

### BACKGROUND

Modular electronics pods have been used in military aircrafts in the past to contain various electronic and communications devices or components. The components are selected based on the particular mission or operation the aircraft is expected to undertake. The modular pods are secured to the underside of the wing or to the fuselage. Alternatively, the pods can be positioned in a cavity in an existing wing or tail of the aircraft.

### SUMMARY

In one example, a stabilizer for an aircraft tail includes a housing defining an interior. The housing is releasably connected to the aircraft tail. A mission-specific equipment package is stowed in the housing interior.

In another example, a stabilizing system for an aircraft tail includes a first pod having a first housing defining an interior and a first mission-specific equipment package stowed in the first housing interior. A second pod includes a second housing defining an interior and a second mission-specific equipment package stowed in the second housing interior. The first and second pods are releasably secured to the aircraft tail.

A method of stabilizing an aircraft includes providing a housing defining an interior and stowing a mission-specific equipment package in the housing interior. The housing is releasably connected to the aircraft tail to define a stabilizer thereof.

Other objects and advantages and a fuller understanding of the invention will be had from the following detailed description and the accompanying drawings.

### BRIEF DESCRIPTION OF THE DRAWINGS

FIG. 1 is an aircraft including an example electronics pod that also functions as a tail stabilizer.

FIG. 2 is a schematic illustration of the pod of FIG. 1.

FIG. 3 is a rear view of the pod of FIG. 1.

FIG. 4A is another example aircraft with an alternative electronics pod functioning as a vertical tail stabilizer.

FIG. 4B is a rear view of the aircraft of FIG. 4A.

### DETAILED DESCRIPTION

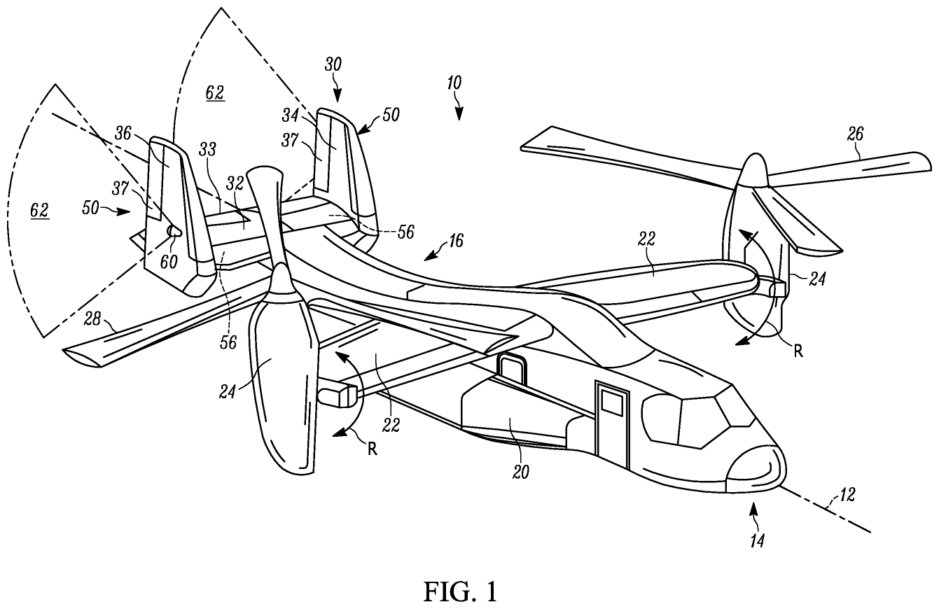

This disclosure relates generally to aircraft stabilizers and, more specifically relates to an electronics pod that also functions as an aircraft stabilizer. FIG. 1 illustrates a military aircraft 10 including an example electronics pod 50. The aircraft 10 is manually powered and extends along a centerline 12 from a first or fore end 14 to a rear or aft end 16. The aircraft 10 includes a fuselage 20 extending generally along the centerline 12.

A pair of wings 22 extends from the fuselage 20 to opposite sides of the centerline 12. A nacelle 24 is rotatably connected to the lateral extent of each wing 22. A drivable rotor 26 is provided on each nacelle 24. The aircraft 10 takes off in helicopter mode when the rotors 26 are rotated while the nacelles 24 extend generally perpendicular to the wings 22 (as shown). Once airborne, the nacelles 24 are rotated in the manner R until they extend generally parallel to the centerline 12 (not shown), thereby allowing the rotating rotors 26 to propel the aircraft 10 forward. Alternatively, the aircraft 10 can be propelled by jet engines (not shown) secured to the wings 22 or fuselage 20.

A tail or empennage 30 is provided at the aft end 16 of the aircraft 10 for helping control aircraft flight. The tail 30 includes a horizontal stabilizer 32 connected to the fuselage 20. A pair of vertical stabilizers 34, 36 are connected to the horizontal stabilizer 32 on opposite sides of the centerline 12. The vertical stabilizers 34, 36 extend substantially perpendicular to the horizontal stabilizer 32 and parallel to one another. Consequently, the tail 30 has an H-shaped configuration.

The horizontal stabilizer 32 helps control the pitch of the aircraft 10. The horizontal stabilizer 32 can include one or more movable control surfaces, such as the elevators 33 shown for changing the aircraft 10 pitch. The vertical stabilizers 34, 36 help control the yaw of the aircraft 10. The vertical stabilizer 34, 36 can also include one or more movable control surfaces, such as the rudders 37 shown, for changing the aircraft 10 yaw. It will be appreciated, however, that the horizontal stabilizer 32 and/or the vertical stabilizers 34, 36 could be free of movable control surfaces and, thus, these stabilizers would not be adjustable in flight.

At least one of the stabilizers 32, 34, 36 is also an electronics pod 50. As shown, both the vertical stabilizers 34, 36 are also pods 50 but the horizontal stabilizer 32 could alternatively or additionally be a pod (not shown). In any case, each pod 50 is a modular, mission-oriented component that allows military aircraft to readily operate under various operational environments. Moreover, the pods 50 form a stabilizing system for the aircraft 10 regardless of how many pods replace traditional aircraft stabilizers.

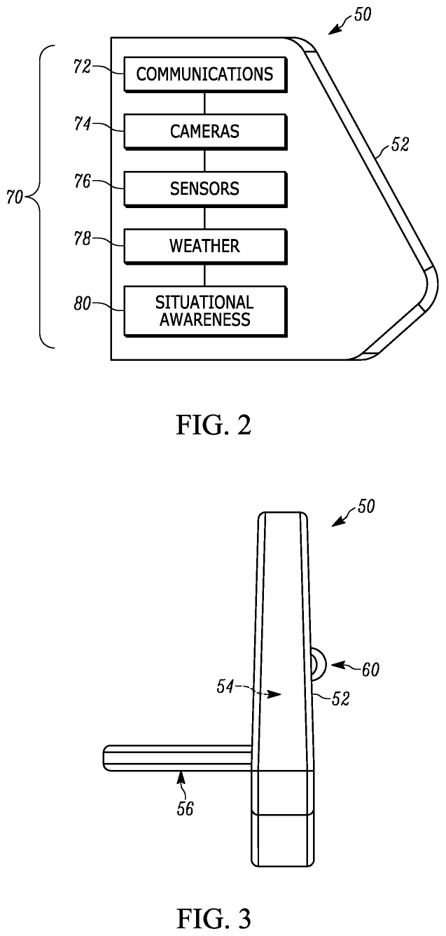

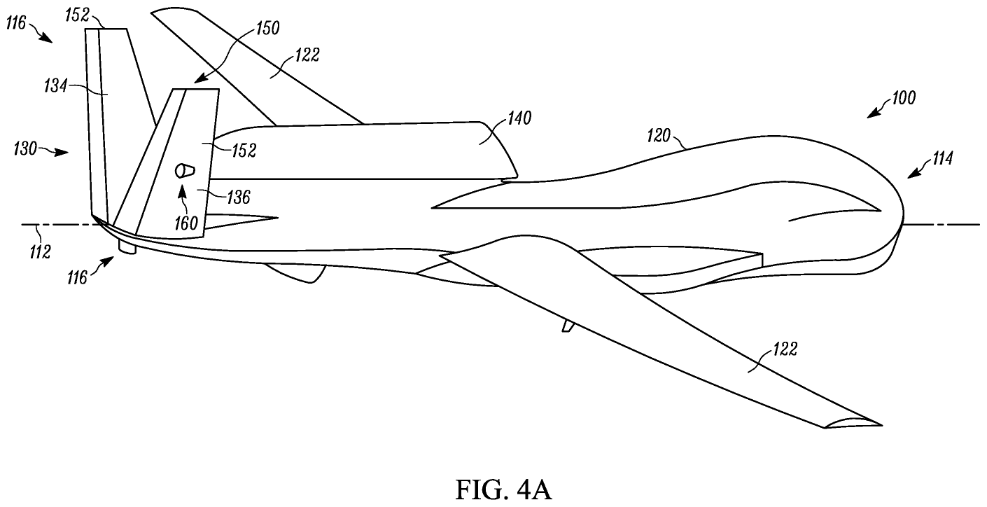

Referring to FIGS. 2-3, the pod 50 includes a housing 52 having the contour of a tail stabilizer. Consequently, the pod 50 in FIG. 1 is shaped identical to a vertical stabilizer for a H-shaped aircraft tail. The same would be true of the housing 52 of a pod 50 used as the horizontal stabilizer 32 (not shown). In any case, the housing 52 includes structure, e.g., a recess, opening, projection, etc., that cooperates with fasteners, brackets, and the like to releasably but securely connect the housing to the remainder of the aircraft tail 30. As shown in FIG. 3, the housing 52 includes a projection 56 to be inserted into a corresponding recess (not shown) in the horizontal stabilizer 32 for connecting the housing to the stabilizer. The connection between the pod 50 and the aircraft 10, as well as the stabilizer contour of the housing 52, ensures that the aircraft maintains the same overall aerodynamic configuration, contour, and functionality whether a traditional stabilizer is provided on the tail 30 or a pod 50 is used as the stabilizer.

The modular, removable nature of the pod 50 allows the pod to be specifically equipped with a desired combination of sensors, processors, communication links, etc., at a location remote from the aircraft 10 and specific to the particular mission the aircraft 10 will undertake. The collective devices, components, etc., contained within/carried by the housing 52 is referred to as a mission equipment package 70.

As shown in FIG. 2, the mission equipment package 70 can include, for example, communications components 72, cameras 74, sensors 76, weather detecting components 78, and/or situational awareness components 80. These components 72-80 are illustrated separately but there can be some overlap or shared components therebetween. Furthermore, it will be appreciated that some components 72-80 could be omitted and/or additional components not shown could be included. One having ordinary skill in the art will appreciate that the mission equipment package 70 can include any known components or devices that would be useful for the aircraft 10 to carry out a particular mission, task or objective.

Some features that can be included in the mission equipment package 70 include, but are not limited to, air-to-ground communications (support for special operations forces (BAO kit), voice relay and bridging, gateway executive processor including UFH, VHF, AM, FM, SINCGARS, HAVEQUICK, SATCOM, and SATCOM DAMA, CDL, Link 16, SADL/EPLRS, PRC-117 and radios operating in C, L, S, and Ku frequency bands); situational awareness data components (multi-TDL relay, bridging and forwarding, Link-16, SADL, EPLRS, VMF, IFDL (BIS), multi-source correlation, and airborne tactical server); broadband communications (high capacity backbone data links, TDL, TCDL, IP waveform and inmarsat); local weather monitoring equipment; cameras (full motion video including air-to-air and ground-to-ground and secure, two-way communications over multiple frequency bands); sensors (sound, light, and image sensors); and lasers (laser spot search and track, laser markers and J-series weapons employment capability).

Depending on the contents of the mission equipment package(s) 70 expected to be used by the aircraft 10, the housing 52 can include one or more openings or recesses 60 that receive sensors/cameras (not shown) of the mission equipment package. The openings 60 can be configured such that the field of view 62 of the sensor/camera does not intersect any portion of the aircraft 10.

It will be appreciated that the intended functionality of the pod 50 will dictate the degree to which components in the mission equipment package 70 can be included therein. More specifically, if the vertical stabilizer 34 and/or 36 does not include a movable control surface 37, the interior of the housing 52 will have room for a more robust mission equipment package 70. On the other hand, a housing 52 including a movable control surface 37 will necessarily include in its interior the mechanics necessary to operate the control surface. Consequently, such a housing 52 can accommodate a less robust mission equipment package 70 due to the reduced available space. The same space considerations are applicable when the pod 50 is used as the horizontal stabilizer 32, i.e., the available housing 52 interior space depends on whether or not the housing includes a movable control surface 33.

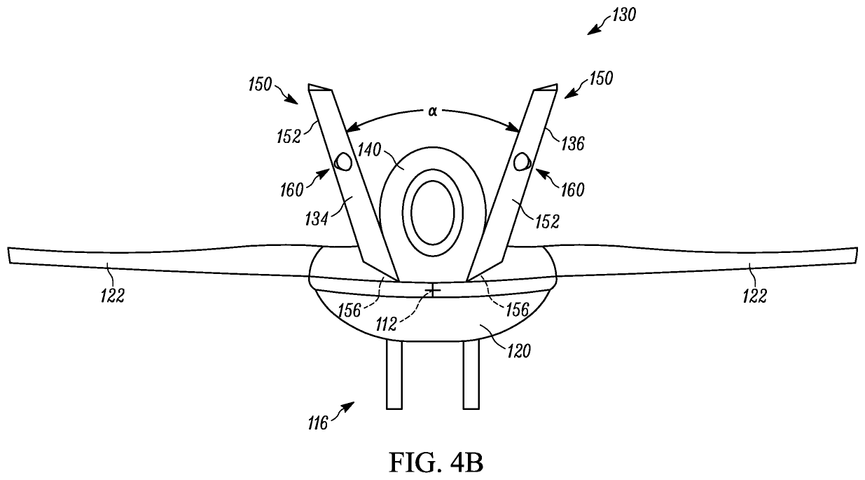

FIGS. 4A-4B illustrate an aircraft 100 including a pod 150 in accordance with another example. As shown, the aircraft 100 is an unmanned drone controlled remotely. The aircraft 100 extends along a centerline 112 from a first or fore end 114 to a rear or aft end 116. The aircraft 100 includes a fuselage 120 extending generally along the centerline 12.

A pair of wings 122 extends from the fuselage 120 to opposite sides of the centerline 112. A jet engine 140 is secured to the fuselage 120 and provides thrust to the aircraft 100. A tail 130 is provided at the aft end 116 of the aircraft 100. The tail 130 includes a pair of vertical stabilizers 134, 136 positioned on opposite sides of the centerline 112 and extending at an angle α relative to one another. Consequently, the tail 130 has a V-shaped or butterfly configuration.

Although not shown, it will be appreciated that one or both of the stabilizers 134, 136 can include the associated movable control surface (similar to the elevators 33 and rudders 37). Regardless, either or both stabilizers 134, 136 are formed by the electronics pod 150. The pod 150 has the same configuration and components as the pod 50 in FIGS. 1-2. The shape of the housing 152, however, is different from the shape of the housing 52 given the difference between the aircraft 10, 100. The stabilizers 134, 136 are releasably connected directly to the fuselage 120 via projection, opening, brackets, etc., in a manner similar to the connection between the pods 50 and the aircraft 10. The pods 150 include the same mission equipment package(s) as the pods 50.

The electronics pods described herein are advantageous because the pods serve the dual purpose of containing any desired mission equipment package(s) while acting as the entire stabilizer (vertical and/or horizontal) for the aircraft tail. As a result, the stabilizer/pod can be readily removed when the aircraft is on the ground and swapped out for the next mission-specific equipment package.

Furthermore, locating the pod on the tail provides a more beneficial field of view for any cameras, sensors, antennas, etc., compared to when the pod is mounted on the wings or fuselage. The location and configuration of the pod described herein also allows the pod to be secured to the aircraft without adversely affecting the aircraft's aerodynamics.

Additionally, the stabilizers and tails on many military aircraft are already configured to be hinged, folded or removed for storage when the aircraft is within a hanger, maritime vessel, etc., to help save space. That said, the stabilizer/pod described herein can be releasably connected to the aircraft in a manner that maintains this desired storage capability [while adding mission-specific equipment packages] without requiring a vastly different connection system than already exists, thereby mitigating cost.

It will be appreciated that although the aircraft shown are both military aircraft the pods described herein could likewise be used in commercial or private aircraft. In such instances, the pods would replace the vertical and/or horizontal tail stabilizers. The mission equipment packages for commercial or private aircraft would also include sensors, cameras, communications capabilities, etc., but would be related to commercial or private flying conditions instead of tactical, military endeavors.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A stabilizer for an aircraft tail, comprising:
a housing defining an interior and being releasably connected to the aircraft tail; and
a mission-specific equipment package stowed in the housing interior.

2. The stabilizer of claim 1, wherein the housing defines an entire vertical stabilizer for the aircraft tail.

3. The stabilizer of claim 1, wherein the vertical stabilizer is releasably connected to a horizontal stabilizer of the aircraft tail.

4. The stabilizer of claim 1, wherein the housing defines an entire horizontal stabilizer for the aircraft tail.

5. The stabilizer of claim 1, wherein the housing is free of a movable control surface.

6. The stabilizer of claim 1, wherein the mission-specific equipment package includes a communications component and a camera.

7. The stabilizer of claim 6, wherein the housing includes an opening through which a field of view of the camera extends.

8. The stabilizer of claim 7, wherein the opening is configured such that the field of view does not intersect the aircraft.

9. A stabilizing system for an aircraft tail, comprising:
a first pod comprising a first housing defining an interior and a first mission-specific equipment package stowed in the first housing interior;
a second pod comprising a second housing defining an interior and a second mission-specific equipment package stowed in the second housing interior, wherein the first and second pods are releasably secured to the aircraft tail.

10. The stabilizer of claim 9, wherein the first and second pods extend parallel to one another to form an H-shaped aircraft tail.

11. The stabilizer of claim 10, wherein the first and second pods are releasably connected to a horizontal stabilizer of the aircraft tail.

12. The stabilizer of claim 9, wherein the first and second pods extend at an angle relative to one another to form an V-shaped aircraft tail.

13. The stabilizer of claim 9, wherein the first and second housings each define an entire vertical stabilizer for the aircraft tail.

14. The stabilizer of claim 9, wherein the first and second housings each define an entire horizontal stabilizer for the aircraft tail.

15. The stabilizer of claim 9, wherein at least one of the first and second housings is free of a movable control surface.

16. The stabilizer of claim 9, wherein the mission-specific equipment package includes for each first and second pod includes a communications component and a camera.

17. The stabilizer of claim 16, wherein each first and second housing includes an opening through which a field of view of the camera extends, each opening being configured such that the fields of view does not intersect the aircraft.

18. A method of stabilizing an aircraft, comprising the steps of:
providing a housing defining an interior;
stowing a mission-specific equipment package in the housing interior; and
releasably connecting the housing to the aircraft tail to define a stabilizer thereof.

19. The method of claim 18, wherein the step of releasably connecting the housing comprises releasably connecting the housing to a horizontal stabilizer of the aircraft tail to define an entire vertical stabilizer of the aircraft tail.

20. The method of claim 18, wherein releasably connecting the housing to the aircraft tail defines an entire horizontal stabilizer of the aircraft tail.
